(19) United States
(12) Patent Application Publication
(10) Pub. No.: US 2023/0049349 A1
(43) Pub. Date: Feb. 16, 2023

(54) SURFACE ANALYSIS METHOD AND SURFACE ANALYSIS DEVICE

(71) Applicant: V TECHNOLOGY CO., LTD., Kanagawa (JP)

(72) Inventor: Michinobu Mizumura, Kanagawa (JP)

(73) Assignee: V TECHNOLOGY CO., LTD., Kanagawa (JP)

(21) Appl. No.: 17/792,206

(22) PCT Filed: Dec. 14, 2020
(86) PCT No.: PCT/JP2020/046547

§ 371 Date: Jul. 12, 2022

(30) Foreign Application Priority Data
Jan. 14, 2020 (JP) 2020-003757

(51) Int. Cl. G01J 3/28; G01N 21/88; G06T 7/00; G06V 10/762; G06V 10/764; G06V 10/32

(52) U.S. Cl. CPC G01J 3/2823; G01N 21/8851; G06T 7/0004; G06V 10/762; G06V 10/764; G06V 10/32

(57) ABSTRACT

The present invention enables highly accurate analysis when visualizing analysis results in spectral imaging.

An surface analysis method includes: acquiring spectral image data regarding a sample surface with use of a spectral camera; extracting n wavelengths dispersed in a specific wavelength range in the acquired spectral image data, and converting spectrums of the wavelengths in the spectral image data into n-dimensional spatial vectors for each pixel; normalizing the spatial vectors of the pixels; clustering the normalized spatial vectors into a specific number of classifications; and identifying and displaying pixels clustered into the classifications, for each of the classifications.

### TECHNICAL FIELD

The present invention relates to a surface analysis method and a surface analysis device.

### BACKGROUND ART

Spectral imaging is known as one type of a surface analysis technique. In this technique, a spectral camera (e.g., a hyperspectral sensor) is used to acquire distribution data (spectral image data) in which spectrum information is stored for each pixel, and the spectrum information is analyzed for each pixel to visualize a distribution of substances, compositions, or the like contained in a sample (e.g., see PTL 1 below).

### CITATION LIST

### Patent Literature

[PTL 1] Japanese Patent Application Publication No. 2016-102769

### SUMMARY OF INVENTION

### Technical Problem

The spectral imaging described above is used in various fields such as the analysis of materials in biological samples, and a statistical technique such as multivariate analysis is used for the analysis of spectral image data. Clustering spectrum information is an effective method of visualizing spectral image data, and when pixels whose spectrum information is clustered into one classification are displayed in the same color, the analysis result of the spectral image data may be visualized as a color image.

When visualizing such spectral image data, in the case of analyzing the surface state of a multilayer film-like sample, it has been confirmed that if the spectral image data of reflected light acquired by the spectral camera is clustered as is, the analysis results are inaccurate due to the influence of interference of light reflected inside the multilayer film, for example.

In particular, in the case of performing spectral imaging in order to, for example, detect a defective part in a multilayer film substrate such as a thin film transistor (TFT), there has been a problem that the outline of a defective part cannot be clearly visualized due to, for example, the interference of light reflected inside the multilayer film, as described above.

The present invention has been proposed to address such problems. Specifically, one example of an object of the present invention is to make it possible to perform highly accurate analysis when visualizing analysis results in spectral imaging, and particularly to make it possible to clearly visualize the outline of a specific analysis target when performing analysis on a multilayer film-like sample.

### Solution to Problem

In order to solve the foregoing problems, one aspect of the present invention has the following configuration.

A surface analysis method includes: acquiring spectral image data regarding a sample surface with use of a spectral camera; extracting n wavelengths dispersed in a specific wavelength range in the acquired spectral image data, and converting a spectrum of each of the wavelengths in the spectral image data into an n-dimensional spatial vector for each pixel; normalizing the spatial vector of each pixel; clustering the normalized spatial vectors into a specific number of classifications; and identifying and displaying pixels clustered into the classifications, for each of the classifications.

### BRIEF DESCRIPTION OF DRAWINGS

FIG. 1 is an illustrative diagram showing steps of a surface analysis method according to an embodiment of the present invention.

FIG. 2 is an illustrative diagram showing a configuration of a surface analysis device.

FIG. 3 is an illustrative diagram showing functions of an information processing part.

FIG. 4 is an illustrative diagram illustrating an n-dimensional spatial vectorization step.

FIG. 5 is an illustrative diagram illustrating a spatial vector normalization step.

FIG. 6 is an illustrative diagram illustrating a clustering step.

FIG. 7 is an illustrative diagram showing examples of clustering visualization (identification and display), where FIG. 7 at (a) shows normalized clustering and FIG. 7 at (b) shows absolute value clustering.

FIG. 8 is an illustrative diagram showing an example of the configuration of a laser repair device that includes the surface analysis device.

### DESCRIPTION OF EMBODIMENTS

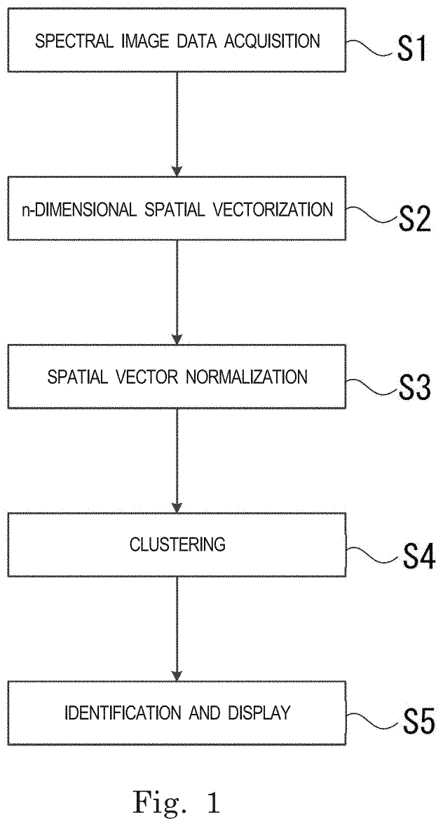

Hereinafter, embodiments of the present invention will be described with reference to the drawings. As shown in FIG. 1, a surface analysis method according to an embodiment of the present invention includes a spectral image data acquisition step S1, an n-dimensional spatial vectorization step S2 performed for each pixel, a spatial vector normalization step S3, a clustering step S4, and an identification and display step S5.

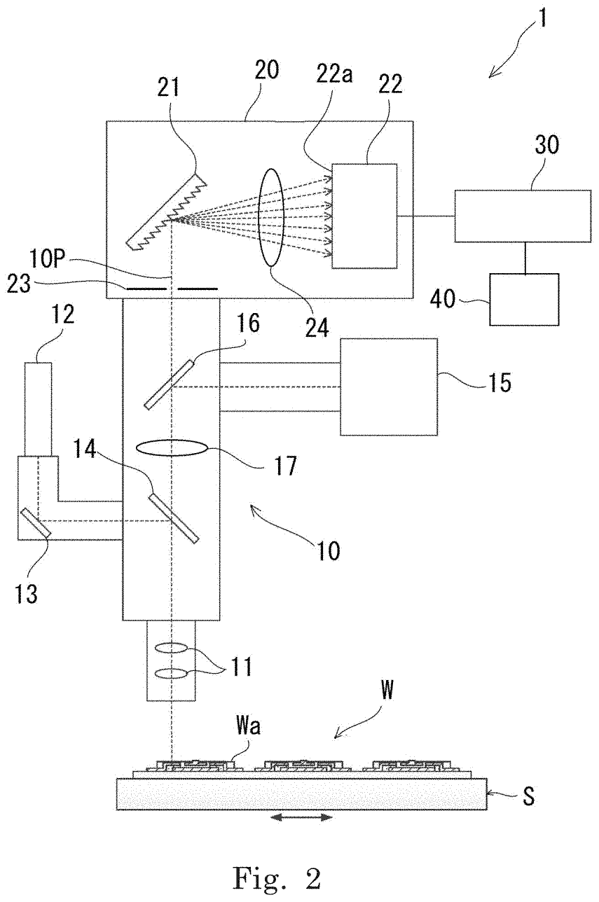

As shown in FIG. 2, the surface analysis device 1 for executing these steps includes a spectral camera 20 that acquires spectral image data regarding the surface of a sample W, an information processing part 30 that analyzes and processes the acquired spectral image data, and a display part 40 for displaying the processing result of the information processing part 30. The surface analysis device 1 shown in FIG. 2 is for magnifying and recognizing a defective part of a multilayer film substrate, which is the sample W, that has been placed on a stage S, and a microscope 10 is disposed under the aforementioned spectral camera 20.

In FIG. 2, the microscope 10 is an optical microscope that irradiates a surface Wa of the multilayer film substrate serving as the sample W with white incident light and obtains a magnified image of a unit region (e.g., a pixel region of a TFT substrate) in which a defective part is to be recognized on the surface Wa, and is provided with an optical system including an objective lens 11, a tube lens 17, and the like, and is also provided with a white light source 12 for irradiating the surface Wa with white incident light and an optical system (mirror 13 and half mirror 14) for the same. The microscope 10 is also provided with a monitor camera 15 for obtaining a monitor image of the magnified image of the surface Wa, and an optical system (half mirror 16) for the same, if necessary.

In the spectral camera 20, a slit 23 and a grating element (diffraction grating) 21 are arranged on a light axis 10P of the optical system of the microscope 10, light reflected by the surface Wa is separated into wavelengths, the resulting light passes through a relay lens system 24 and forms an image on an imaging surface 22a of a two-dimensional camera 22, and a line spectral technique is used to acquire spectrum information regarding the magnified image of the surface Wa for each pixel of the imaging surface 22a.

In the spectral image data acquisition step S1 in FIG. 1, spectral image data (spectrum information for each pixel) regarding the surface Wa in the sample W is acquired by using the spectral camera 20 described above.

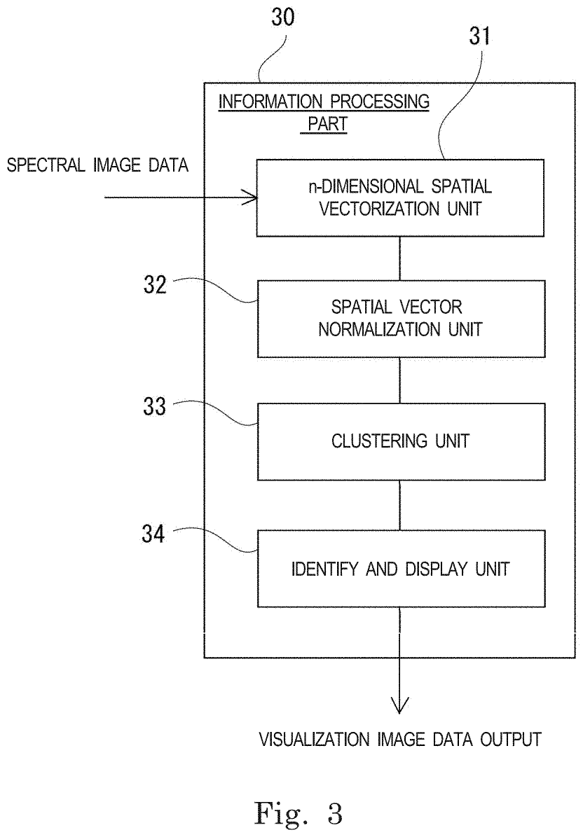

As shown in FIG. 3, the information processing part 30 includes an n-dimensional spatial vectorization unit 31, which is software for executing the above-described n-dimensional spatial vectorization step S2 for each pixel, a spatial vector normalization unit 32, which is software for executing the spatial vector normalization step S3, a clustering unit 33, which is software for executing the clustering step S4, and an identify and display unit 34, which is software for executing the identification and display step S5. As a result, input spectral image data is visualized and output as display image data.

Regarding the analysis and processing steps performed by the information processing part 30, the n-dimensional spatial vectorization step S2 is a step for extracting n wavelengths dispersed in a specific wavelength range in the spectral image data acquired in the spectral image data acquisition step S1, and converting the spectrum of each wavelength in the spectral image data into an n-dimensional spatial vector.

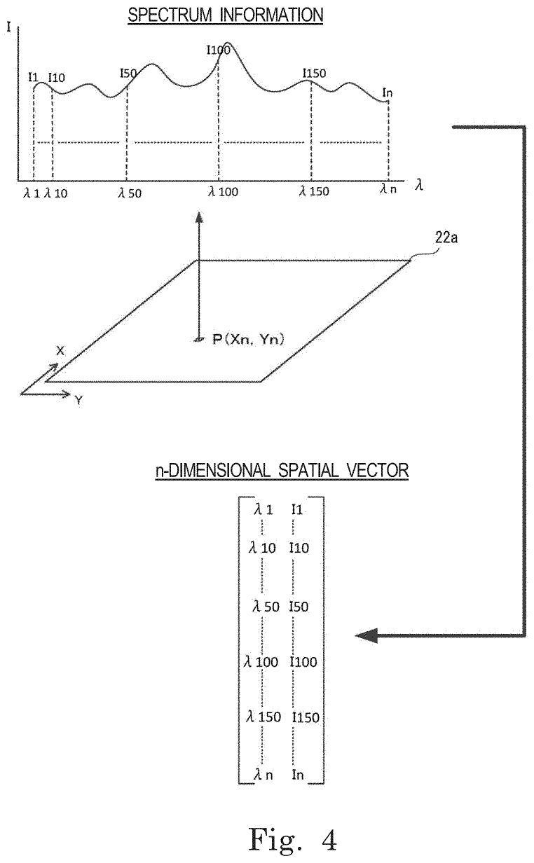

As shown in FIG. 4, the acquired spectral image data includes one piece of spectrum information for each pixel P (Xn, Yn) of the imaging surface 22a of the two-dimensional camera 22. A wavelength range of λ1=400 nm to λn=700 nm is selected from the wavelength range of the spectrum information, the selected wavelength range is divided into n−1 pieces (e.g., n=200), n wavelength (λ1 to λn) components are extracted, and an n-dimensional spatial vector is obtained by combining the wavelengths (λ1 to λn) with the intensities (I1 to In) of the corresponding wavelengths.

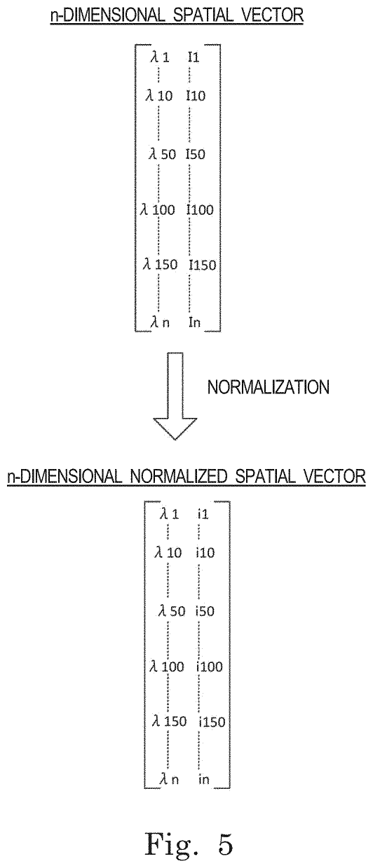

Then, in the spatial vector normalization step S3, as shown in FIG. 5, the n-dimensional spatial vectors are normalized to obtain n-dimensional normalized spatial vectors. The normalization mentioned here is processing for obtaining a unit vector whose length (norm) is 1 while maintaining the direction of the n-dimensional spatial vector, and multiplying the n-dimensional spatial vectors by the inverse of the norm of the spatial vector to obtain a unit vector with a norm of 1 (n-dimensional normalized spatial vector).

In the clustering step S4, the normalized n-dimensional spatial vectors of the pixels are clustered into a specific number of classifications. The number of classifications here is set according to the analysis target. For example, in the case of extracting a defective part of a multilayer film substrate such as a TFT substrate, a specific number of classifications is set according to the structure of the TFT substrate, and a classification group is defined for vectors that do not correspond to any of the classifications (i.e., are unclassifiable).

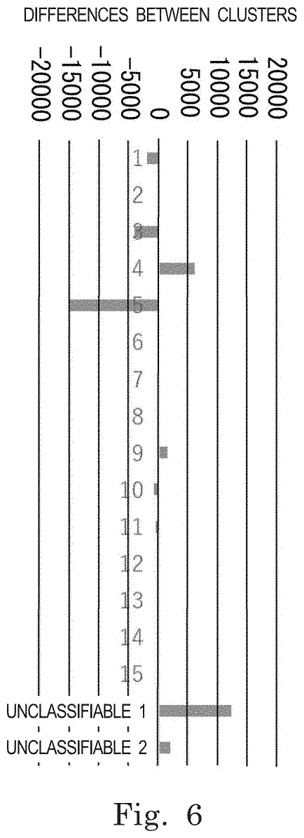

Cluster can be performed using GMMs (Gaussian Mixture Models) obtained by machine learning, for example. FIG. 6 shows an example of the result of clustering the normalized spatial vectors of all pixels in the case where 15 classifications are set according to the structure of the TFT substrate, and two classifications are provided for unclassifiable vectors, and here a histogram of the number of pixels in each classification is shown using the difference from a histogram having a normal pattern. A part for which the classification has a large difference from the histogram having a normal pattern can be recognized as a defective part.

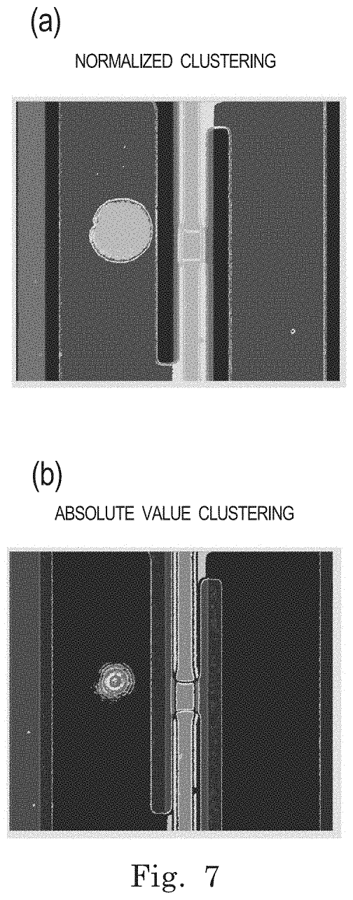

FIG. 7 shows display examples in the identification and display step S5 for visualizing the result of the clustering step S4 described above. Here, the pixels clustered in the respective classifications are visualized (displayed as an image) with use of contrast and color. FIG. 7 at (a) shows the result of clustering normalized n-dimensional spatial vectors (normalized clustering), and FIG. 7 at (b) shows the result of clustering without normalizing the n-dimensional spatial vectors (absolute value clustering).

In the case where normalized clustering is visualized as shown in FIG. 7 at (a), the outline of a characteristic portion (e.g., a defective part) can be clearly visualized as shown in the figure. On the other hand, when the spectral image data of the same sample surface is subjected to absolute value clustering, as shown in FIG. 7 at (b), the outline of the characteristic portion is not clear due to the influence of the interference of light reflected inside the multilayer film, for example.

In this way, with the surface analysis method or the surface analysis device according to an embodiment of the present invention, highly accurate analysis can be performed when analyzing a characteristic portion of a surface by clustering acquired spectral image data and visualizing the clustering result. In particular, in the case of identifying and displaying a defective part of a multilayer substrate, the outline of a defective part can be clearly visualized, thus making it possible to realize highly accurate defective part repair (laser repair).

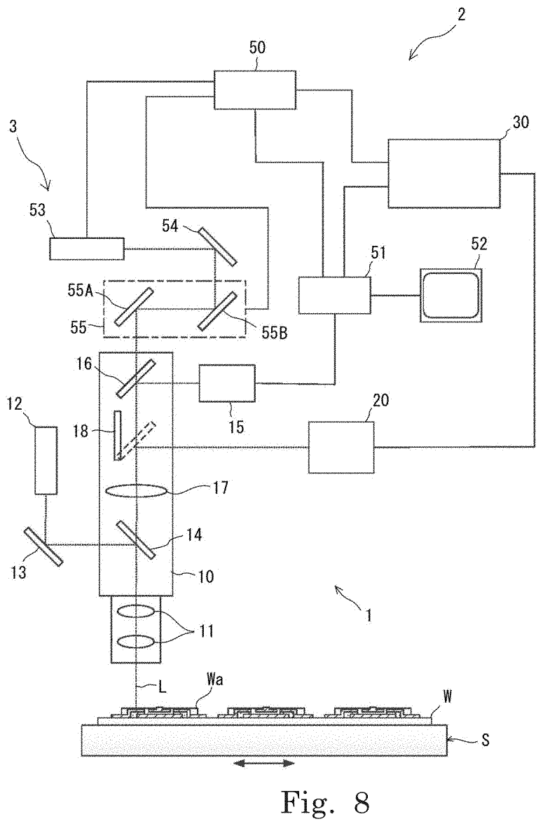

FIG. 8 shows a configuration example of a laser repair device 2 that includes the surface analysis device 1 described above. The laser repair device 2 performs repair work by irradiating a defective part, which was recognized by visualization by the information processing part 30 described above, with a laser beam, and includes a laser irradiation part 3 for emitting a laser beam L on the same axis as the light axis of the microscope 10.

The laser irradiation part 3 includes a laser light source 53 and a laser scanner 55, for example, and the laser beam L emitted from the laser light source 53 passes through a mirror 54 and galvanometer mirrors 55A and 55B of the laser scanner 55 and enters the optical system of the microscope 10, and then the surface Wa of the unit region magnified by the microscope 10 is irradiated with the laser beam L.

In the illustrated example, a switching mirror 18 capable of moving into and out of the light axis of the microscope 10 is provided, and when the switching mirror 18 is moved into the light axis of the microscope 10, light reflected by the surface Wa enters the spectral camera 20 and the surface analysis device 1 is operated, and then when the switching mirror 18 is moved out of the light axis of the microscope 10, it is possible to operate the laser repair device 2 that irradiates the surface Wa with the laser beam L.

With the laser repair device 2 that includes the surface analysis device 1, first, the surface analysis device 1 is operated and the information processing part 30 transmits, to the laser control part 50, information indicating the presence or absence of a defective part, a defective part position if a defective part is present, and the like.

The laser control part 50 determines whether or not laser repair is to be performed based on the above-described information transmitted by the information processing part 30, and in the case of performing laser repair, a laser irradiation range and a workflow are set based on defective part position information and the like.

Also, in the illustrated example, the magnified image obtained by the microscope 10 is also supplied to the monitor camera 15, and laser repair can be performed while observing the image captured by the monitor camera 15 on the display device 52. At this time, the two-dimensional image acquired by the monitor camera 15 is subjected to image processing by the image processing part 51 and transmitted to the laser control part 50 and the information processing part 30, and the laser irradiation part 3 can also be controlled based on the two-dimensional image.

According to this laser repair device 2, a defective part of the multilayer film substrate W can be recognized by the surface analysis device 1 in detail with a clear outline, and laser repair work setting can be performed based on the recognized information. This makes it possible to perform high-quality repair work that is not affected by the skill of the operator, and also enables highly efficient and high-quality repair work by automating the process from defective part recognition to repair work.

Although embodiments of the present invention have been described in detail with reference to the drawings, the specific configurations are not limited to these embodiments, and design changes and the like that fall within a range not deviating from the gist of the present invention are included in the present invention. Also, the above-described embodiments can be combined by applying the techniques thereof to each other as long as no particular contradictions or problems arise regarding the objectives and configurations thereof.

### REFERENCE SIGNS LIST

1 Surface analysis device
2 Laser repair device
3 Laser irradiation part
10 Microscope
10P Light axis
11 Objective lens
12 White light source
13 Mirror
14, 16 Half mirror
15 Monitor camera
17 Tube lens
18 Switching mirror
20 Spectral camera
21 Grating element
22 Two-dimensional camera
22a Imaging surface
23 Slit
30 Information processing part
31 n-dimensional spatial vectorization unit
32 Spatial vector normalization unit
33 Clustering unit
34 Identify and display unit
40 Display part
50 Laser control part
51 Image processing part
52 Display device
53 Laser light source
54 Mirror
55 Laser scanner
55A, 55B Galvanometer mirror
S Stage
W Sample (multilayer film substrate)
Wa Surface
L Laser beam

What is claimed is:

1. A surface analysis method comprising:
acquiring spectral image data regarding a sample surface with use of a spectral camera;
extracting n wavelengths dispersed in a specific wavelength range in the acquired spectral image data, and converting a spectrum of each of the wavelengths in the spectral image data into an n-dimensional spatial vector for each pixel;
normalizing the spatial vector of the each pixel;
clustering the normalized spatial vectors into a specific number of classifications; and
identifying and displaying pixels clustered into the classifications, for each of the classifications.

2. The surface analysis method according to claim 1,
wherein the sample surface is a surface of a TFT substrate, and
a defective part is identified and displayed by the pixels clustered into the classifications.

3. A surface analysis device comprising:
a spectral camera configured to acquire spectral image data regarding a sample surface;
an information processing part configured to analyze and process the spectral image data; and
a display part configured to display a processing result of the information processing device,
wherein the information processing part includes:
a unit of extracting n wavelengths dispersed in a specific wavelength range in the acquired spectral image data, and converting a spectrum of each of the wavelengths in the spectral image data into an n-dimensional spatial vector for each pixel;
a unit of normalizing the spatial vector of the each pixel;
a unit of clustering the normalized spatial vectors into a specific number of classifications; and
a unit of identifying and displaying pixels clustered into the classifications with the display part, for each of the classifications.

4. A laser repair device that performs repair work by irradiating a defective part with laser beam, the defective part being recognized with use of the surface analysis device according to claim 3.
